(19) United States
(12) Patent Application Publication
(10) Pub. No.: US 2007/0157537 A1
(43) Pub. Date: Jul. 12, 2007

(54) Molded stone architectural product having a foam core

(76) Inventors: Dave Nicolson, Orem, UT (US); Marc Stephenson, Orem, UT (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/900,969

(22) Filed: Jul. 28, 2004

Related U.S. Application Data
(60) Provisional application No. 60/490,626, filed on Jul. 28, 2003.

(51) Int. Cl. B28B 3/00; B29C 45/14

(52) U.S. Cl. 52/596; 264/279; 264/279.1; 264/333

(57) ABSTRACT

An architectural cast stone product for use in building construction, which has a unitary shell made of a molded cementitious material that partially surrounds and is affixed to a foam core. The architectural cast stone product has a mounting surface including an exposed surface of the foam core and an exposed surface of the shell. The architectural cast stone product is made by obtaining a front pattern having a desired surface configuration for the architectural cast stone product, obtaining a foam core, affixing the foam core to a backer, affixing the front pattern to the backer that together form a mold, pouring a cementitious material into the mold and into contact with the foam core, at least partially curing the cementitious material to form the architectural cast stone product, and removing the front pattern and backer from the architectural cast stone product.

### CROSS-REFERENCED RELATED APPLICATIONS

This application claims the benefit of U.S. Provisional Application No. 60/490,626, filed Jul. 28, 2003.

### BACKGROUND OF THE INVENTION

The present invention relates to molded stone architectural products having a foam core. The present invention further relates to a slurry casting method for the manufacture of foam core architectural stone products.

The use of natural cut and carved stone is often too expensive to be used in most homes and buildings. Natural stone is also heavy and subject to seismic limitations. Over the years, various products and construction methods have been developed to simulate cut and carved stone on home and building exteriors. For example, many commercially available cementitious products may be used to prepare three-dimensional shapes, which when cured, may serve as window sills, crown moldings, window surrounds, moldings around doors wall caps, keystones, columns, column caps and bases, etc. With limitations similar to natural stone, architectural stone products may be produced by casting cementitious material in a mold to produce cast solid architectural stone products. Others cover foam shapes with a thin layer of cementitious material, either at a jobsite or at a shop. Each of these methods has limitations that have created a need in the art. Cast solid architectural stone products are heavy and expensive because of the amount of cementitious material required to fabricate the product. The method of coating a three-dimensional shaped substrate is wasteful and often the product is of poor quality. Material is often wasted because too much cementitious slurry is made and much material falls to the ground during the coating process. Poor or uneven quality results from the difficulty in applying a uniform coating on the shaped substrate. In addition, this method is also expensive because of the labor skill and time required in applying the coating.

Accordingly, a need exists for molded stone architectural products that are efficiently manufactured at low cost and have a high quality three-dimensional shape and surface finish. There is a further need for molded stone architectural products that efficiently use materials, are inexpensive to manufacture, are relatively lightweight, and are uniform in appearance. There is still a further need for molded stone architectural products that do not require fabrication at the job site.

### BRIEF SUMMARY OF THE INVENTION

The present invention has been developed in response to the present state of the art, and in particular, in response to the problems and needs in the art that have not yet been fully solved by currently available architectural stone products. The present invention relates to a method of preparing a mold which is used to manufacture architectural cast stone products containing a foam core. As used herein, an architectural cast stone product is a three dimensional decorative and/or functional structure that is intended to have a stone-like appearance for exterior or interior applications. Examples of architectural cast stone products include but are not limited to columns, caps, bases, balustrades, barrel vaulting, window sills, crown molding, wall caps, keystones, fireplace mantles, column caps and bases, moldings around doors, wall caps, trim stones, quoins, and door and window surrounds.

The architectural cast stone product of the invention may include a foam core and a unitary shell made of a molded cementitious material that partially surrounds the foam core. The shell is formed of a cementitious material that is cast in a mold around the foam core. During the casting process, a slurry of cementitious material partially surrounds the foam core and fills the crevices, cavities, and unevenness in the surface of the foam core to affix the shell to the core as the shell cures. Cementitious material is material having the properties of cement. The cementitious material may include a wide variety of aggregates including, but not limited to, stone fragments, glass fiber, glass particles, sand, polymers, and other materials.

The architectural cast stone product includes a mounting surface that includes an exposed surface of the foam core and an exposed surface of the shell. The mounting surface is a surface that may be hidden from view once it is attached to or installed on a building structure. The shell of the architectural cast stone product includes a wraparound extension that follows the foam core from a first surface at least partially onto the mounting surface. This wraparound extension may be the exposed surface of the shell on the mounting surface. The wraparound extensions provide the appearance that the architectural cast stone product is solid stone. The exposed surface of the foam core limits the size of the shell and thus limits the total weight of the architectural cast stone product. In forming the mounting surface, the wraparound extension may extend parallel to an adjoining surface of the foam core and nonparallel to an adjoining surface of the shell. The adjoining surface of the foam core may be the exposed surface of the foam core of the mounting surface.

The shell of the architectural cast stone product may also include one or more projections. A projection is a part of the shell that extends into the foam core and may positively affix the shell to the core. The projection may have any shape that assists in affixing the shell to the core. It may be a simple bump extending into the foam core. The projection may have a T or L shape, with the top of the T being formed within the foam core and the base of the T extending from a surface of the shell and the base of the L being formed within the foam core and the top of the L extending from a surface of the shell. It may be a geometric shape, such as a rectangular shape, a trapezoid shape, a triangular shape, a shape that follows an arc or other geometric shape.

The shell may be cast so that it has the appearance of a miter joint. In other words, the shell may extend in a first direction and a second direction with the second direction disposed at an angle to the first direction. Where the first direction and the second direction meet, a corner or miter joint is formed. The foam core may be made of one piece or of multiple pieces, but the shell is a solid cast unitary body.

The foam core may be made of any type of foamed polymer that has sufficient strength to support the cast shell. Foam is any material containing a distributed mass of gas bubbles. The foam core may be made of a variety of foamed polymer materials including, but not limited to, expanded polystyrene, polyurethane, polyethylene, polypropylene, polyester, polyvinyl chloride, polyacrylonitrile, ABS, polyamide, polyoxymethylene, polycarbonate, rubber, phenolic, polyimide, acrylic, flouropolymer, epoxy, or silicone polymers. The foamed polymer core should be capable of being shaped in a three dimensional form through molding, machining, extrusion, or any other generally known method in the art.

Expanded polystyrene (“EPS”) is an excellent foam core material because of its ease of processing, relatively low density, and relatively high strength. EPS is a generic term for polystyrene and styrene copolymers that are shaped, expanded, and molded into foam shapes. EPS may be purchased in large blocks having a density from about 1 lbs/ft³ or greater. In some applications, a density of about 1 lbs/ft³ to about 2.0 lbs/ft³ may be preferred. In other applications, a density under 1 lbs/ft³ may be desired. EPS may also be easily shaped by a computer-assisted foam-cutting machine that uses a hot wire to cut the EPS block into the desired three dimensional shapes.

For example, a method for manufacturing an architectural cast stone product for use in building construction may include the steps of obtaining a front pattern having a desired surface configuration for the architectural cast stone product, obtaining a foam core, affixing the foam core to a backer, affixing the front pattern to the backer, pouring a cementitious material into the mold and into contact with the foam core, at least partially curing the cementitious material to form the architectural cast stone product, and removing the front pattern and backer from the architectural cast stone product. The front pattern and the backer together may form a mold. In some configurations, a cap may be used to close one end of the mold.

Obtaining a front pattern may include cutting an EPS foam block with a hot wire or computer-assisted foam-cutting machine that has been pre-programmed with the desired shape of the front pattern. The front pattern may also be obtained by thermoforming a plastic sheet over a model or using standard machining practices to obtain the desired shape of the front pattern. Alternatively, any method known in the art for making a suitable mold may be used to create the front pattern, such as molding, machining, or extrusion. The front pattern is a first half of a mold in which the shell is formed around the foam core. Of course, the front pattern may be made from any metal, wood, plastic, ceramic, composite, or material that is able to give the cementitious slurry a desired shape while the cementitious slurry cures.

If an EPS foam block is cut, the foam core may be cut from the same block as the front pattern during the same cutting operation. The foam core may also be prepared by forming the core material in a mold and allowing the foam core to cure. Alternatively, standard machining practices or any other known method may be used to prepare the foam core.

The front pattern is preferably shaped and disposed relative to the foam core to create a cavity at least about ¼ inch broad between the front pattern and the foam core. In most applications, the cavity ranges from about ¼ inch to about 1 inch broad. In some configurations, the cavity may be about ⅛ of an inch broad. The breadth of the cavity determines the thickness of the shell.

The foam core may include a three dimensional surface configuration of the foam core similar to the surface of the front pattern. When this is done, the shell of the architectural cast stone product may have a substantially uniform thickness. Controlling the shell thickness may allow a minimum amount of cementitious material to be used, which further lightens the architectural cast stone product and lowers manufacturing costs.

The front pattern and the foam core may be attached to the backer. The backer forms part of the mold in which the shell is formed around the foam core. The backer helps to prevent the cementitious slurry from flowing out of the mold and supports the foam core. The backer also positions the foam core relative to the front pattern so that shell is formed with a desired thickness. The foam core is preferably affixed to the backer by mechanical fasteners that include, but are not limited to, tape, cord, nails, screws, nuts and bolts, straps, clamps, and various other types of fasteners. The foam core may also be affixed to the backer by adhesives including hot glue (polyethylene) or other types adhesives that do not dissolve the foam core.

The front pattern may be affixed to the backer by mechanical fasteners that include, but are not limited to, tape, cord, nails, screws, nuts and bolts, straps, clamps, and various other types of fasteners. The front pattern is preferably affixed to the backer by adhesives including hot glue (polyethylene) or other types of adhesives that do not dissolve or damage the backer or the front pattern. Alternatively, the front pattern may be affixed to the backer by abutting other molds or heavy objects against the front pattern and/or backer.

Before the backer and front pattern are affixed together, the backer and front pattern may be covered with a mold release. The mold release may include any known mold release known in the art. For example, vegetable oil may be used as a mold release.

Once a mold is formed, a cementitious slurry is poured into the mold. The mold may be vibrated while the cementitious material is poured into the mold. Additionally, after the cementitious material is poured into the mold, the mold may be vibrated. The vibration helps remove air bubbles from the slurry of cementitious material. Vibrating the mold to remove air bubbles from the cementitious material usually increases the quality of the shell. The cementitious material is then allowed to cure.

When the architectural cast stone product is partially cured or after it is fully cured, the front pattern and the backer are removed. Removal may be easier while the architectural cast stone product is only partially cured. Once removed, the architectural cast stone product may be sanded, polished, or undergo other surface treatments to produce the desired surface finish. Of course, the surface finish of the front pattern directly affects the surface finish of the architectural cast stone product. For instance, if denser EPS foam is used as a front pattern, then the surface finish of the architectural cast stone product will be smoother. Where the backer was affixed to the foam core, the foam core will be exposed to view and will form part of the mounting surface of the architectural cast stone product. However, the mounting surface is preferably not seen once the architectural cast stone product is mounted on a building structure. This partial coverage of the foam core by the shell provides the benefit of reducing the weight and expense of the architectural cast stone product.

The cementitious material may be firmly attached to the foam core in a number of ways. First, the foam used is not perfectly smooth, so the cement slurry is able to fill the small crevices and pores of the foam core. The three dimensional surface configuration increases the surface area of the foam core for even greater bonding. Additionally, a bonding agent may also be used to encourage adhesion of the cementitious material to the foam core. Wraparound extensions may also be formed that wrap around and partially cover the exposed side of the foam core. The wraparound extensions are formed when grooves are cut into the foam core, the grooves are filled by the cementitious slurry, and the cementitious slurry is allowed to cure forming the architectural cast stone product. Protrusions of the shell may extend into the foam core, which further increases the shell surface area for improved bonding. The protrusions, like the wraparound extensions, help to grip the foam core.

The mold may also include an affixed cap. The cap is used to close an area of the mold that is not enclosed by the front pattern or the backer. An area of the mold may be left open to provide a conduit for the cementitious material to enter and fill the mold.

To provide an architectural cast stone product with the appearance of a miter joint a suitable mold must be obtained. This may be accomplished by cutting a first mold and a foam core at a desired angle. A second mold and a second foam core are also cut at a desired angle. Then, the first mold and foam core are affixed to second mold and the second foam core, respectively, to make a miter mold. In this way, multiple molds may be combined to form a miter mold to produce an architectural cast stone product with the appearance of one or more miter joints.

A miter mold for casting an architectural cast stone product with the appearance of a miter joint may also be produced by machining, thermomolding, or molding the miter joint shape into the front pattern directly, instead of combining two molds. In this way, a single mold can be used to cast an architectural cast stone product with the appearance of a miter joint. Additionally, the foam core may be a unitary body and thus provide better support to the shell as compared to multiple separate pieces of a foam core that have been affixed to each other with adhesives or mechanical fasteners.

Once the miter mold and foam core have been prepared, a cementitious slurry is poured into a cavity of the miter mold formed between the front pattern and the backer. The cementitious slurry is then allowed to at least partially cure in the miter mold. The resulting architectural cast stone product has the appearance of a miter joint. This method produces an architectural stone product that has a first part and a second part extending at an angle from the first part so that where the first part meets the second part, a miter joint or corner is formed.

An architectural cast stone product according to the invention may have a shell with an average thickness that may be greater than or equal to about ¼ of an inch. The shell may also have an average thickness from about ¼ inch to about 1 inch or greater. In other configurations the thickness of the shell may be about ⅛ of an inch.

An architectural cast stone product prepared within the scope of the invention limits waste of the cementitious stone base material by using only the amount that is necessary to evenly cover a foam core. In addition, an architectural cast stone product requires minimal labor to prepare its mold, cast the architectural cast stone product, and install the finished product on a building structure. The architectural cast stone product according to the invention may be made in any shape including, but not limited to, linear, geometric, curved forms, and ornate three dimensional shapes.

These and other features of the present invention will become more fully apparent from the following description, or may be learned by the practice of the invention as set forth hereinafter.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exploded perspective view illustrating a front pattern, backer, and cap of a mold and a foam core;

FIGS. 2a and 2b are perspective views illustrating the assembly of the mold with a foam core;

FIG. 3 is a perspective view illustrating the assembled mold and foam core;

FIG. 4 is a perspective view of a finished architectural cast stone product removed from the mold;

FIG. 5a is an exploded view of a mold and a second mold, each with a cut to create a miter mold;

FIG. 5b is a perspective view of an architectural cast stone product having the appearance of a miter joint resulting from this mitered mold;

FIG. 6 is a perspective view of an alternative configuration of an architectural cast stone product;

FIG. 7 is a perspective view of a curved architectural cast stone product that extends along an arc;

FIG. 8 is a perspective view of a half column; and

FIG. 9 is a perspective view of an alternative half of a column within the scope of the invention.

### DETAILED DESCRIPTION OF THE INVENTION

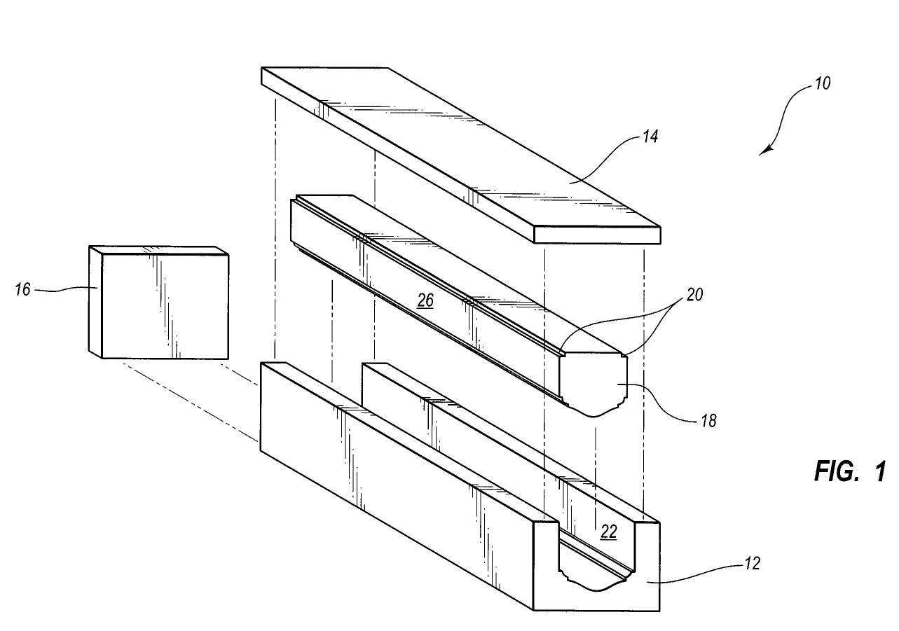

The presently preferred embodiments of the invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 through 9 is not intended to limit the scope of the invention, but is merely representative of presently preferred embodiments of the invention.

For this application, the phrase “connected to” refers to any form of interaction between two or more entities, including mechanical, electrical, magnetic, electromagnetic, and thermal interaction. The phrase “attached to” refers to a form of mechanical coupling that restricts relative translation or rotation between the attached objects. The terms “integrally formed” refer to a body that is manufactured integrally, i.e., as a single piece, without requiring the assembly of multiple pieces. Multiple parts may be integrally formed with each other if they are formed from a single work piece.

FIG. 1 is an exploded perspective view illustrating a mold 10. As shown, the mold 10 for producing an architectural cast stone product comprises a front pattern 12, backer 14, and cap 16. A foam core 18 is positioned within the mold 10. Each part in this embodiment is composed of EPS, which is cut by a computer assisted foam-cutting machine (not shown). Such foam-cutting machines use one or more heated wires to quickly cut the foam. Of course, the EPS may be manually cut using hot wires or other known cutting methods.

In this embodiment, EPS is used because EPS is inexpensive, commercially available, and easy to process. In addition, EPS that has a density of about 1 lb/ft³ is sufficient to provide an adequate surface finish on the exterior of the cast product. Of course, higher density EPS foam, with densities in the range from about 1.5 and 2 lb/ft³, may be used to provide a smoother surface finish. Recycled EPS foam on the other hand tends to provide a rough and inconsistent surface finish, but it may also be used to make a foam core, front pattern, backer, cap, or any other parts of a mold.

In addition to foam, the parts of the mold, including a front pattern, backer, and optionally a cap, may be made of any type of material including, but not limited to, metal, ceramic, glass, composite, wood, or plastic. Of course, use of these other materials may require different processing methods than what is described in this embodiment. For example, a front pattern could be cut in metal using electrical discharge machining (“EDM”), standard machining processes, forging, or even casting. A plastic mold could be thermoformed or machined.

The foam core 18 may be made of any foamed plastic. In this embodiment, EPS is used because EPS is inexpensive and easy to form in three dimensional shapes in order to make an architectural cast stone product. For example, a foam core may be shaped by molding, reaction injection molding, or standard machining methods. The foam core 18 may also be cut by a computer-aided foam-cutting machine. Often foam cutting machines use a hot wire to cut EPS foam. Linear shapes are made by placing an EPS foam block on a computer-aided foam-cutting machine, which controls the movement of a hot wire through the EPS foam block. Corner pieces are made by mitering a completed mold and attaching the mitered ends to produce a mold with the desired corner angle. Curved shapes are produced by using a preformed hot wire mounted on a pivot arm at the desired radius. The preformed hot wire is then rotated through an EPS foam block to cut the mold shape and foam core.

The front pattern 12 and the foam core 18 may be cut for efficiency from the same large solid block of EPS. The foam core 18 includes one or more grooves 20 cut into the foam core 18 to shape wraparound extensions of a shell formed from a cementitious material. The wraparound extensions help to grip the foam core 18 and help affix the cementitious material to the foam core of the architectural cast stone product. Also, the cap 16 may optionally be integrally formed with either the front pattern 12 or the backer 14.

The exposed internal surfaces 22 of mold 10 may be coated with a mold release for easier removal of the architectural cast stone product. A variety of mold release materials known in the art may be used, including but not limited to silicon, Teflon, oil, or wax. For instance, cooking spray may be used as the mold release. However, some mold release agents may dissolve or weaken the foam mold and thus should be avoided.

In contrast, the foam core 18 is not coated with a mold release because the foam core 18 preferably adheres to the cementitious material. Typically, the cementitious slurry will adhere to the foam core and be affixed to the foam core when fully cured, so no bonding agents are necessary. Of course, all surfaces to which the cementitious material is expected to adhere should be clean and free of oil, grease, dirt, decomposed foam or anything that might inhibit adhesion of the cementitious material to the foam. However, the exposed external surface 26 of the foam core 18 may be coated with a bonding agent known in the art to promote adhesion of a cementitious material to foam.

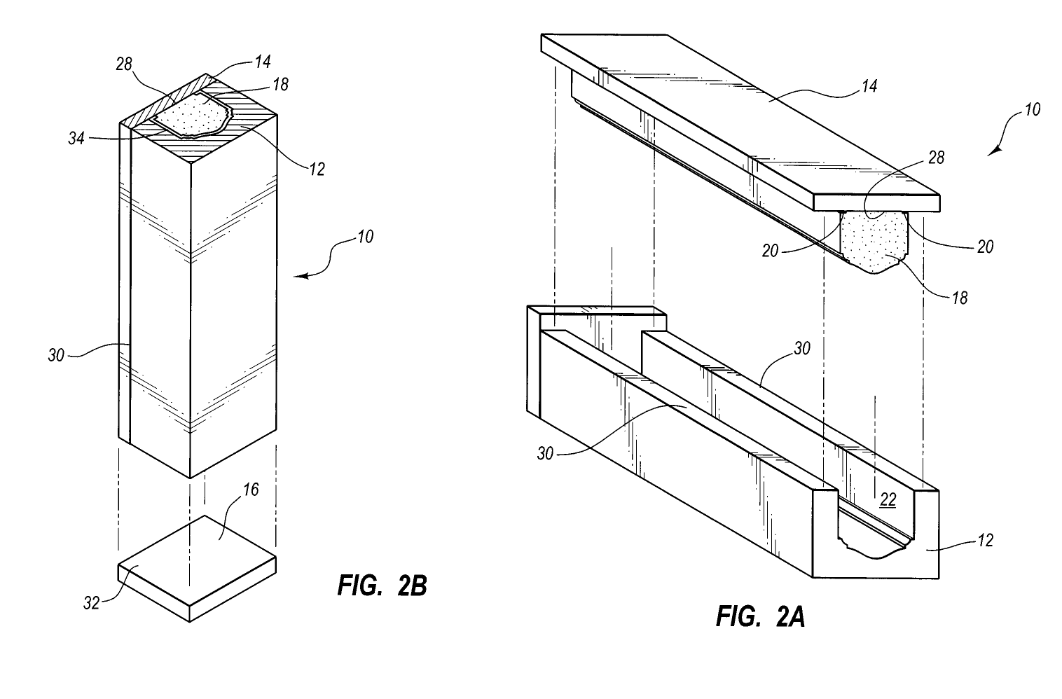

FIGS. 2a and 2b illustrate the assembly of the mold 10 with a foam core 18 in two sub-views. As shown in FIG. 2a, the foam core 18 may be affixed to the backer 14 by an attachment joint 28 between the foam core 18 and the backer 14. The attachment joint 28 may use adhesives or mechanical fasteners to affix the foam core 18 and the backer 14. If an adhesive is used, the amount of adhesive needs to be enough to affix the two parts together, but not so much that it is difficult to separate the backer 14 from the foam core 18.

An attachment joint 30 may connect the pattern 12 to the backer 14 by using an adhesive that may affix the front pattern 12 with the backer 14 by applying adhesive generously enough to prevent the mold 10 from breaking while the cementitious material is poured and cured. It will be appreciated that a lesser quantity of adhesive may be used in attachment joint 30 if other means are provided for affixing the front pattern 12 and backer 14 together. Such affixing means may include, but are not limited to, tape, clamps, screws, bolts, or even other molds positioned adjacent to mold 10.

As shown in FIG. 2b, the attachment joint 32 of the cap 16 to the front pattern 12 and the backer 14 again uses a generous amount of adhesive. The adhesive in attachment joints 28, 30, and 32 may comprise hot glue or other material capable of bonding the foam mold 10 together and prevent the slurry from leaking out while the cementitious material is poured and curing. In some cases, tape, clamps, or fasteners may function as an adhesive.

If a corner or miter joint is needed, the mold 10 may be cut to a desired angle. The mold 10 is then aligned with and affixed to a second mold (not shown). For instance, if a right angle is needed, both the mold 10 and the second mold may be cut at a 45 degree angle. The mold 10 and the second mold are then affixed in order to provide a shell of an architectural cast stone product with the appearance of a miter joint. Also shown in FIG. 2b is the cavity 34 that is formed by the mold, which gives shape to poured cementitious slurry.

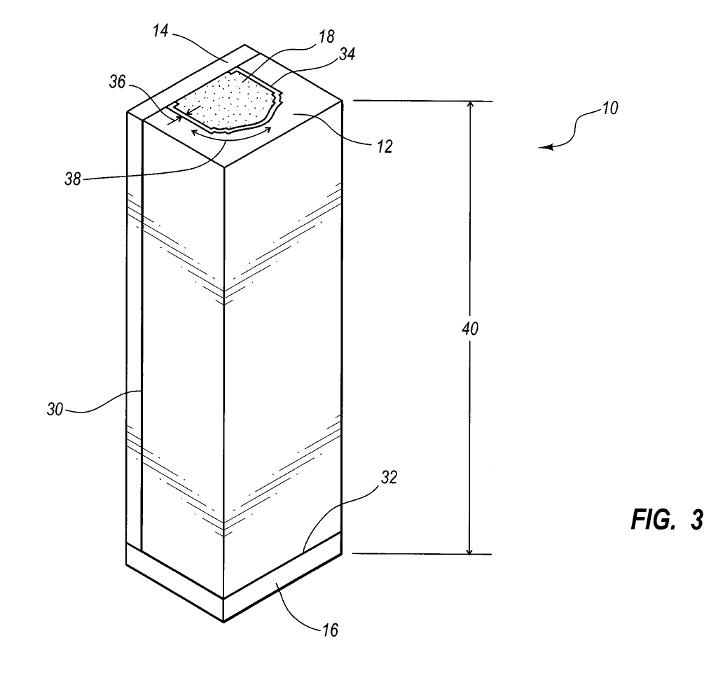

FIG. 3 is a perspective view illustrating the assembled mold 10. As shown, the front pattern 12 is attached to the backer 14 and the cap 16 via attachment joints 30 and 32, respectively. The foam core 18 is attached to the backer 14 via attachment joint 28 and the backer is securely attached to the cap 16 via attachment joint 32. The mold 10 as shown is ready to be filled with cementitious slurry.

The cavity 34 is defined by a breadth 36, width 38, and a length 40. In this embodiment, the breadth 36 is the shortest distance across the cavity 34 between the front pattern 12 and the foam core 18. The width 38 is a dimension that is perpendicular to the breadth 36 of the cavity 34. Finally, the length 40 is a dimension extending through the mold 10 and is perpendicular to breadth 36 and width 38 in the mold 10 shown in FIG. 3.

Once the mold 10 is fully assembled, the cavity 34 is filled with cementitious slurry that hardens and cures to form a three-dimensional architectural cast stone product. The cavity 34 may have a breadth 36 in the range from about ¼ inch to about 1 inch, which may result in an equivalent thickness of a shell of cementitious material around the foam core 18. Of course, the breadth 36 of the cavity 34 can be varied from about ⅛ of an inch to beyond 1 inch to fit circumstances as needed. If the cavity 34 is broader, then the cementitious slurry may be thick or more viscous and may contain various aggregate materials. If the cavity 34 is narrower, then the cementitious slurry may be thin or less viscous.

While the slurry is being poured, the mold 10 may be vibrated to help the cement slurry settle into the mold and help rid the cementitious slurry of air bubbles. The mold 10 may also be vibrated after the cementitious material is poured. The cementitious material used in this embodiment may be a portland cement, high aluminum cement, silicate cement, magnesium oxychloride cement or any other material known in the art having the qualities of cement. Polymeric binders and aggregates may be used to simulate stone and function as a cementitions material. A presently preferred cementitions material is a limestone coating material sold by ArcusStone Products, Inc., Oakland, Calif.

The mold 10 once filled is set aside to cure. Removal of the architectural cast stone product from the mold 10 while the architectural cast stone product is only partially cured may facilitate removal of the front pattern 12. It has been found that removal of a fully cured architectural stone structure may be more difficult. Removal while partially cured may produce a cleaner surface finish and may render the use of mold release agents unnecessary.

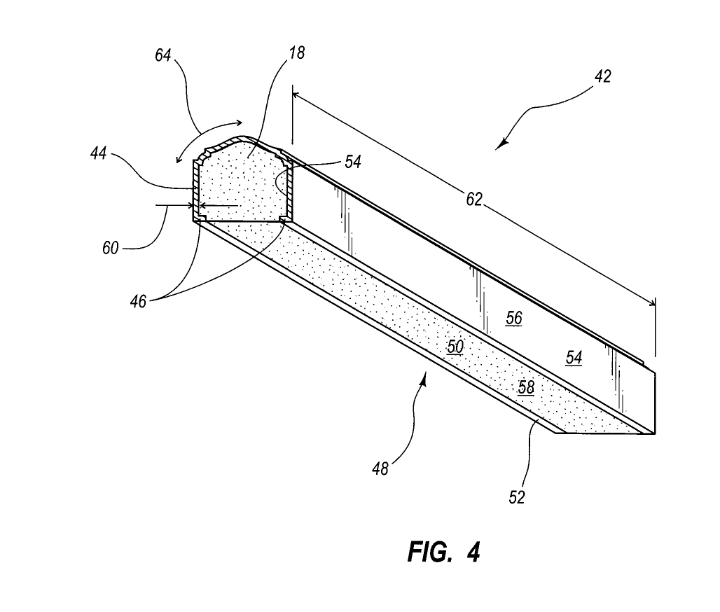

FIG. 4 shows a perspective view of an architectural cast stone product 42 removed from the mold 10 (not shown). The architectural cast stone product 42 can be up to 8 feet in length or longer if needed. Molds for longer architectural cast stone products may be assembled by attaching additional molds and/or sections to create a larger mold. Of course, smaller architectural cast stone product of three feet or shorter in length may be easier to manufacture, transport, and install.

As shown, the architectural cast stone product 42 includes a unitary shell 44 and the foam core 18. The shell 44 is integrally formed around the foam core 18. The shell 44 may comprise wraparound extensions 46 to help affix the foam core 18 to the shell 44. The wraparound extensions 46 also provide the architectural cast stone product 42 with increased structural and mechanical strength and stability without the need for the shell 44 to fully enclose the foam core 18.

The architectural cast stone product 42 also includes a mounting surface 48. The mounting surface 48 has an exposed surface 50 of the foam core 18 and an exposed surface 52 of the shell 44. In some configurations, the exposed surface 52 of the mounting surface 48 is also a surface of the wraparound extension 46 of the shell 44.

In this configuration, the wraparound extension 46 follows the foam core 18 from a first surface 54 of the foam core 18 at least partially onto the mounting surface 48. The wraparound extension 46 of the shell 44 may also be described as extending nonparallel to an adjoining surface 56 of the shell 44 and parallel to an adjoining surface 58 of the foam core 18.

The unitary shell 44 of this embodiment may be generally defined by three dimensions; thickness 60, length 62, and width 64. The thickness 60 of the shell 44 may be greater than about ¼ of an inch. Typically, the thickness 60 of the shell 44 is from about ¼ inch to about 1 inch. Of course, the thickness 60 of the shell 44 may vary through the width 64 and throughout the length 62.

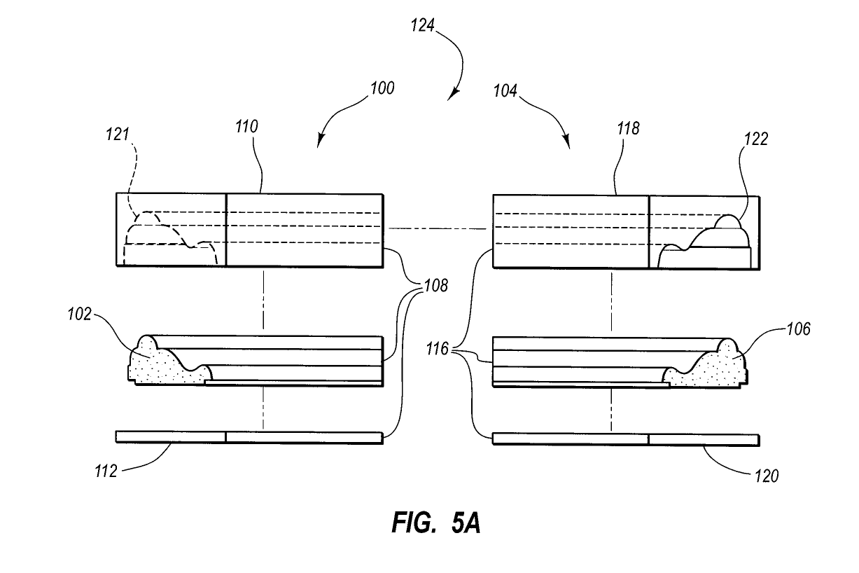

FIG. 5a illustrates an exploded view of a mold 100 having a foam core 102 with a second mold 104 having a second foam core 106. The mold 100 and foam core are cut or formed at an angle to create a miter 108. The mold 100 includes a front pattern 110 and a backer 112. In this embodiment, the front pattern 110 is affixed to the backer 112 so that a cap (not shown) is not needed. The second mold 104 and second foam core 106 are similarly cut at an angle to form a second miter 116. The second mold similarly includes a second front pattern 118 and a second backer 120.

The front pattern 110 and the second front pattern 118 include a profile 121 and a second profile 122, respectively. The profile 121 is defined by hidden lines in FIG. 5a. The front pattern 110 extends around the profile 121 to close the mold 100 and leave only the miter 108 open when the front pattern 110 is affixed to the backer 112. This may be accomplished by using a separate cap or by having the cap structure integrally formed with the front pattern 110 as shown. The profiles 121 and 122 give shape to a shell of an architectural cast stone product produced in the mold 100 and second mold 104.

Once cut, the miter 108 and the second miter 116 are affixed together with an adhesive to create a miter joint between the mold 100 and the second mold 104 and the foam core 102 and the second foam core 106. Of course, mechanical fasteners may also be used to affix the miter 108 with the miter 116.

Once the mold 100 and the second mold 104 are assembled and affixed together to form a miter mold 124, the miter mold 124 is positioned so that cementitious material may be poured into and fill the cavity of the miter mold 124. An opening for filling the miter mold 124 is provided in the second mold 104. Once the miter mold 124 is filled, the cementitious material is allowed to partially or fully cure around the foam core 102 and the second foam core 106. Thereafter, the front panel 110, second front panel 118, the backer 112, and the second backer 120 are removed. If necessary, the resulting architectural cast stone product is allowed to fully cure.

FIG. 5b illustrates an architectural cast stone product 126 removed from the miter mold 124 (shown in FIG. 5a). As shown, the architectural cast stone product 126 includes a unitary shell 128 affixed to the foam core 102 and the second foam core 106. The shell 128 has the appearance of a miter joint 130 and also includes wraparounds 132. The shell 128 of this configuration has a substantially uniform thickness 134, preferably greater than about ¼ of an inch. The thickness 134 may range from about ¼ inch to about 1 inch or be as thin as about ⅛ of an inch. Greater thicknesses are within the scope of the invention, but they are not preferred.

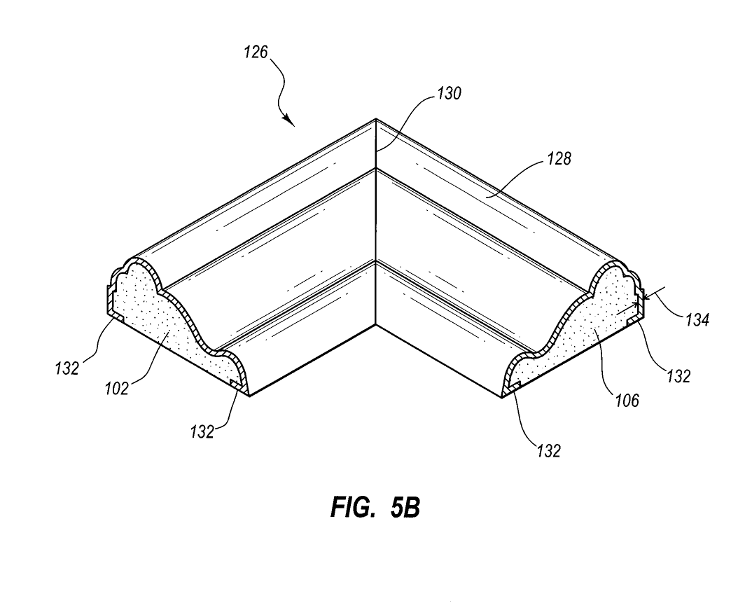

FIG. 6, illustrates an alternative configuration of an architectural cast stone product 150. The architectural cast stone product 150 includes a shell 152 of cementitious material that partially covers a foam core 154. The shell 152 includes wraparounds 156 that extend parallel to an adjoining surface 158 of the foam core 154 and nonparallel to an adjoining surface 160 of the shell 152. The wraparounds 156 extend opposite a surface 162 of the shell 152 with a portion of the foam core 154 in between. The positioning of the wraparounds 156 allows the shell 152 to grip the foam core 154 with a minimum amount of material. This architectural cast stone product 150 may be used as crown molding, where its light weight is an advantage over solid cut or cast stone products.

As crown molding, architectural cast stone product 150 has a large mounting surface 163 that covers two sides of the architectural cast stone product 150. The mounting surface 163 allows the architectural cast stone product 150 to be mounted into the corner 164 formed where a surface of a ceiling 166 meets a surface of a wall 168 of a structure 170. The architectural cast stone product 150 may be attached to the surfaces of the ceiling 166 and the wall 168 of the structure 170 by mechanical fasteners and/or adhesives.

The wraparounds 156 are formed and seated in grooves 172. The wraparounds 156 provide an exposed surface 174 of the shell 152 that is part of the mounting surface 163. The exposed surface 176 of the foam core 154 is another part of the mounting surface 163. When attached to the structure 170, the mounting surface 163 is not open to view. Only the shell 152 remains exposed to view and provides the appearance of a cut or carved stone crown molding.

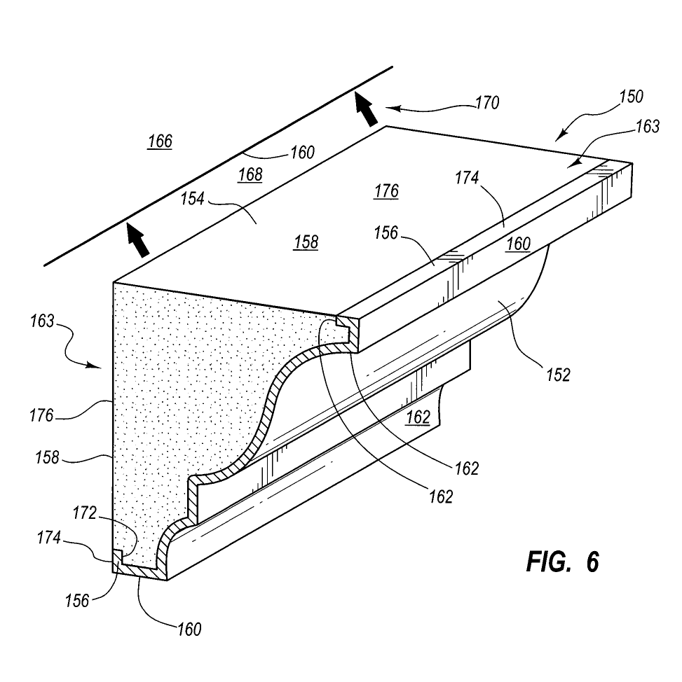

FIG. 7, illustrates another configuration of an architectural cast stone product 180 that extends along a curve 182. The architectural cast stone product 180 includes a shell 184 that partially covers a foam core 186. This architectural cast stone product 180 may be used as a window surround or a door surround. This configuration also includes wraparounds 188.

The foam core 186 and mold (not shown) may be cut by moving a shaped hot wire (not shown) through an arc or curve to cut a foam block. Of course, the foam core 186 may also be molded or machined. Therefore, the architectural cast stone product within the scope of the present invention may have many different shapes.

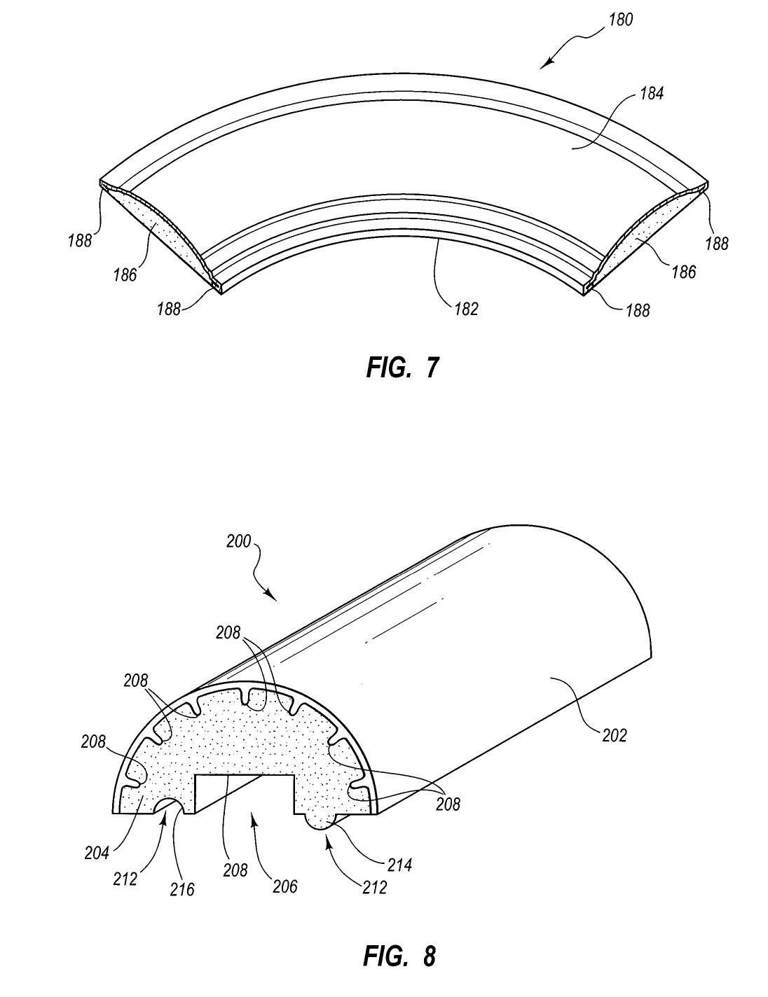

FIG. 8 illustrates an alternative configuration of another cast stone product 200 within the scope of the invention. The architectural cast stone product 200 is shaped as half of a cylindrical column. The architectural cast stone product 200 includes a shell 202 partially surrounding a foam core 204. The architectural cast stone product 200 also includes a mounting surface 206.

The shell 202 extends over a 180 degree arc and includes projections 208 that extend into the foam core 204. The projections 208 help affix the shell 202 to the foam core 204.

The mounting surface 206 includes a channel 210 that allows the architectural cast stone product 200 to fit around a structural element, such as a beam, of a building. The mounting surface 206 also includes assembly features 212 that allow the architectural cast stone product 200 to be properly aligned and securely attached to a complimentary architectural cast stone product (not shown). Assembly features 212 may be configured to allow the architectural cast stone product 200 to be properly spaced relative to a structural support or the complimentary architectural cast stone product (not shown). As shown, the assembly features 212 may have an extension 214 and a groove 216 that would engage reciprocal features of a similar architectural cast stone product.

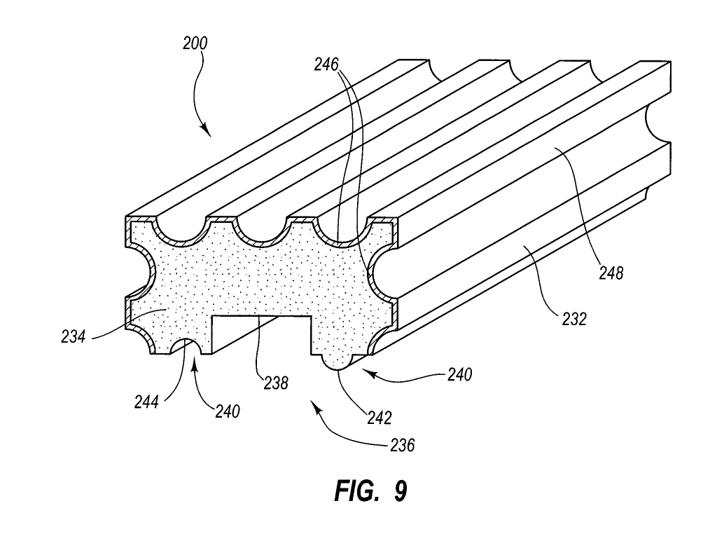

FIG. 9 illustrates yet another alternative architectural cast stone product 230. The architectural cast stone product 230 is shaped as half of a square, fluted column. The architectural cast stone product 230 includes a shell 232 partially surrounding a foam core 234. Similar to FIG. 8, the architectural cast stone product 230 includes a mounting surface 236 having a channel 238 and assembly features 240 that include an extension 242 and groove 244.

In contrast to the architectural cast stone product 200 of FIG. 8, the architectural cast stone product 230 includes large flutes 246 that help affix the shell 232 to the foam core 234. The flutes 246 extend into the foam core 234 and are nonparallel to an adjacent surface 248 of the shell 232. The flutes 246 are a type of projection and allow the architectural cast stone product 230 to avoid the use of wraparound extensions.

The architectural cast stone product 230, when combined with one or more complimentary architectural cast stone products (not shown), provides a light-weight, aesthetically-pleasing column for use in building structures or landscaping as a freestanding column.

The use of a shell of cementitious material covering a foam core provides the pleasing appearance of solid cast stone or natural stone architectural products. The light weight of architectural cast stone products within the scope of the invention facilitates installation and positioning on building structures. The minimal use of cementitious material in the architectural cast stone products also significantly lessens the costs of using architectural stone products in building structures for aesthetic or structural purposes.

The method of producing architectural cast stone products within the scope of the invention also provides architectural cast stone products with consistent qualities such as thickness of the shell and uniformity of appearance. The method of producing architectural cast stone products also provides for the production of standard, interchangeable, as well as custom architectural cast stone products.

The present invention may be embodied in other specific forms without departing from the structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

Claims

1

-

8

. (canceled)

9. A method for manufacturing an architectural cast stone product for use in building construction, the method comprising:
obtaining a front pattern having a desired surface configuration for the architectural cast stone product;
obtaining a foam core;
affixing the foam core to a backer;
affixing the front pattern to the backer, wherein the front pattern and the backer together form a mold having a single continuous mold cavity between the foam core, front pattern and backer;
introducing a cementitious material into the mold cavity and into contact with the foam core;
at least partially curing the cementitious material to form the architectural cast stone product comprised of a single continuous cementitious shell at least partially surrounding the foam core; and
removing the front pattern and backer from the architectural cast stone product in a manner so that the foam core and cementitious shell remain attached together as the architectural cast stone product.

10. The method of claim 9, wherein the method further comprises affixing a cap to the mold.

11. The method of claim 9, further comprising coating the front pattern with a mold release.

12. The method of claim 9, further comprising vibrating the mold to remove air bubbles from the cementitious material.

13. The method of claim 9, further comprising obtaining a second mold and joining the mold with the second mold so that the mold and the second mold may be used to form a single architectural cast stone product.

14. The method of claim 13, wherein the mold is joined to the second mold in a miter joint.

15. The method of claim 9, wherein the front pattern is made of foam having a density of at least about 1 lbs/ft³.

16. The method of claim 9, wherein the front pattern is made of foam having a density of up to about 2.0 lbs/ft³.

17. The method of claim 9, wherein the front pattern is made from expanded polystyrene foam.

18. The method of claim 9, wherein the front pattern comprises foam and is formed utilizing a computer-assisted foam-cutting machine.

19. The method of claim 9, wherein the foam core is expanded polystyrene.

20. The method of claim 9, wherein forming the foam core further comprises shaping a surface of the foam core similarly to a surface of the front pattern.

21. The method of claim 9, wherein the front pattern is shaped and positioned relative to the foam core to create a mold cavity at least ¼ inch broad between the front pattern and the foam core.

22. The method of claim 9, wherein the front pattern is shaped and positioned relative to the foam core to create a mold cavity about ¼ inch to about 1 inch broad between the front pattern and the foam core.

23. The method of claim 9, the foam core of the architectural stone product including an exposed mounting surface upon removal of the front pattern and backer from the architectural cast stone product.

24. The method of claim 23, an end of the cementitious shell being substantially flush with the exposed mounting surface of the foam core and forming part of a mounting surface of the architectural cast stone product.

25. The method of claim 24, the foam core including a recess adjacent to the mounting surface that forms part of the mold cavity into which the cementitious material is introduced so that the cementitious shell comprises a wraparound extension that extends laterally into the recess of the foam core.

26. The method of claim 9, the surface configuration of the front pattern being non-planar with three-dimensional features.

27. The method of claim 9, further comprising surface treating the cementitious shell to yield a desired surface finish.

28. The method of claim 27, wherein surface treating the cementitious shell comprises polishing the cementitious shell.

29. An architectural cast stone product manufactured according to the method of any of claims 9, 24 or 29.

30. A method for manufacturing an architectural cast stone product for use in building construction, the method comprising:
obtaining a front pattern having a desired surface configuration for the architectural cast stone product, the surface configuration being non-planar with three-dimensional features;
obtaining a foam core having a mounting surface;
positioning the mounting surface of the foam core adjacent to a backer and affixing the foam core to the backer;
affixing the front pattern to the backer, wherein the front pattern, foam core and backer together define a mold cavity that partially surrounds the foam core;
introducing a cementitious material into the mold cavity and into contact with the foam core;
at least partially curing the cementitious material to form the architectural cast stone product comprised of a cementitious shell partially surrounding the foam core; and
removing the front pattern and backer from the architectural cast stone product in a manner so that the foam core and cementitious shell remain attached together and the mounting surface of the foam core is exposed.

31. The method of claim 30, the cementitious shell being a single continuous structure and having an end that is substantially flush with the exposed mounting surface of the foam core upon removal of the front pattern and backer so as to form part of a mounting surface of the architectural cast stone product.

32. The method of claim 30, the foam core including a recess adjacent to the mounting surface, the end of the cementitious shell comprising a wraparound extension that extends laterally into the recess of the foam core.

33. An architectural cast stone product manufactured according to the method of claim 30 or 32.

34. A method for manufacturing an architectural cast stone product for use in building construction, the method comprising:
obtaining a front pattern having a desired surface configuration for the architectural cast stone product;
obtaining a foam core having a mounting surface and a recessed portion adjacent to the mounting surface;
positioning the mounting surface of the foam core adjacent to a backer and affixing the foam core to the backer so that the recessed portion defines a space between the backer and a portion of the foam core adjacent to the mounting surface;
affixing the front pattern to the backer in a spaced-apart relationship relative to the foam core so that the front pattern, foam core and backer together define a mold cavity that partially surrounds the foam core and extends into the space between the backer and a portion of the foam core defined by the recessed portion;
introducing a cementitious material into the mold cavity and into contact with the foam core;
at least partially curing the cementitious material to form the architectural cast stone product comprised of a cementitious shell partially surrounding the foam core; and
removing the front pattern and backer from the architectural cast stone product in a manner so that the foam core and cementitious shell remain attached together, the mounting surface of the foam core is exposed, and the cementitious shell includes a wraparound portion that extends laterally into the recessed portion of the foam backer so as to form part of a mounting surface of the architectural cast stone product.

35. The method of claim 34, the cementitious shell being a single continuous structure and having an end comprising the wraparound extension that is substantially flush with the exposed mounting surface of the foam core.

36. An architectural cast stone product manufactured according to the method of claim 34.

37. A method for manufacturing an architectural cast stone product for use in building construction, the method comprising:
obtaining a front pattern having a desired surface configuration for the architectural cast stone product;
obtaining a foam core;
affixing the foam core to a backer;
affixing the front pattern to the backer, wherein the front pattern and the backer together form a mold having a mold cavity between the foam core, front pattern and backer;
introducing a cementitious material into the mold cavity and into contact with the foam core;
partially curing the cementitious material to form the architectural cast stone product comprised of a cementitious shell at least partially surrounding the foam core;
removing the front pattern and backer from the architectural cast stone product while the cementitious material is only partially cured in a manner so that the foam core and cementitious shell remain attached together as the architectural cast stone product; and
surface treating the cementitious shell to yield a desired surface finish.

38. The method of claim 37, wherein surface treating the cementitious shell comprises sanding the cementitious shell.

39. The method of claim 37, wherein surface treating the cementitious shell comprises polishing the cementitious shell.

40. The method of claim 39, wherein the cementitious shell is polished while the cementitious material is only partially cured.

41. An architectural cast stone product manufactured according to the method of any of claims 37, 39 or 40.
